(19) United States
(12) Patent Application Publication
(10) Pub. No.: US 2024/0229259 A1
(43) Pub. Date: Jul. 11, 2024

(54) A METHOD FOR PRODUCING ELECTRODES FOR ELECTROLYSIS

(71) Applicant: HYDROGENPRO ASA, Porsgrunn (NO)

(72) Inventors: Lars Pleth NIELSEN, Porsgrunn (NO); Richard ESPESETH, Porsgrunn (NO); Per MØLLER, Porsgrunn (NO); Marcus Viktor KRAGH-SCHWARZ, Porsgrunn (NO); Morten Linding FREDERIKSEN, Porsgrunn (NO)

(21) Appl. No.: 18/561,821

(22) PCT Filed: May 19, 2022
(86) PCT No.: PCT/EP2022/063589

§ 371 Date: Nov. 17, 2023

(30) Foreign Application Priority Data
May 19, 2021 (EP) 21174639.1

(51) Int. Cl. C25B 11/052; C23C 8/02; C23C 8/08; C23C 8/80; C25B 1/04; C25B 11/031; C25B 11/061; C25B 11/075; C25D 5/10; C25D 5/12; C25D 5/40; C25D 5/48; C25D 5/50

(52) U.S. Cl. CPC C25B 11/052; C23C 8/02; C23C 8/08; C23C 8/80; C25B 11/031; C25B 11/061; C25B 11/075; C25D 5/10; C25D 5/12; C25D 5/40; C25D 5/48; C25D 5/50; C25B 1/04

(57) ABSTRACT

The present invention relates to a method for producing an electrode for alkaline electrolysis based on a composition of sulfides on a Ni foam substrate. In a step. S2) there is performed a sulfiding on the Ni substrate. The step of sulfiding results in the formation of electrocatalytic active nano-sites with Ni—S compounds. It is found that these nano-sites are capable of reducing the so-called overpotential of the electrodes during alkaline water electrolysis, and the production of electrodes may be significantly simplified. In particular, already existing electrolyzer units may benefit from this invention by on-site application of the improved method.

### TECHNICAL FIELD OF THE INVENTION

The present invention relates to a method for producing an electrode, such as an anode and/or a cathode, to be used in alkaline water electrolysis, the electrode for alkaline electrolysis is preferably based on a composition of sulfides on a Ni foam substrate, optionally with a metal being Mo, Ni, Co, Fe and/or W. In particular, the present invention further relates to a corresponding electrode for alkaline water electrolysis and a corresponding electrolysis system for alkaline water electrolysis.

### BACKGROUND OF THE INVENTION

Hydrogen is a very interesting and important part of the energy system—especially in the upcoming Power-to-X (PtX) strategies. By converting green electricity from wind turbines, photovoltaic cells and water-based power plants into hydrogen, the energy can either be used directly in the transport sector, stored for later use, or converted together with carbon dioxide (CO₂) into so-called green methane, green methanol, green diesel or green aviation fuel. Hereto comes that it is relatively cheaper to transport energy as hydrogen through piping systems as compared to transporting energy as electricity through copper wires over the electric grid.

Water electrolysis can be broadly classified into three different technologies: Solid Oxide Electrolysis (SOE), Proton Exchange Membrane (PEM) Electrolysis and Alkaline Water Electrolysis (AWE). Furthermore, on a more academic level, water can also be split into Hz and O₂ by thermolysis, photolysis and microbial electrolysis although these technologies are much less matured.

Hydrogen production by alkaline water electrolysis (AWE) is a well-established technology up to the megawatt level. H₂ is produced from the cathode surface forming hydroxyl ions (OH—), which migrate through a porous diaphragm membrane to the anode under the influence of the electrical field between the anode and cathode. Subsequently, two hydroxyl ions (OH—) are discharged forming oxygen (O₂) and water (H₂O). Oxygen atoms combines at the surface of the anode and escapes as oxygen (O₂).

The underlying reactions are:

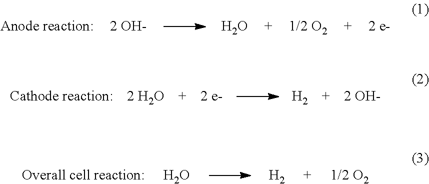 [SMILES: O ; "2 H2O" ; "H2" ; O ; "H2"]

The anode/cathode for alkaline water electrolysis is typically a nickel-based material. Nickel is stable in the concentrated KOH solution. Lifespans beyond 25 years and decades of stability of Ni-based electrodes in alkaline water electrolysis have been reported. Conventionally, porous nickel, such as e.g. a nickel foam or different Ni alloys, has been used as standard electrode material to increase the surface area.

There is continuously ongoing research and development activities focusing on improved electrodes for alkaline electrolysis by lowering the overpotential for hydrogen and oxygen formation.

One recent example is US patent application US2019106797 (Siemens), wherein an electrolytic cell for alkaline water electrolysis with in-situ anode activation is disclosed. The electrolytic cell comprises: an anode; a cathode wherein at least a part of a surface of the cathode comprises an electrically conducting stable material, such as nickel, and an anode catalytic material, such as cobalt, manganese, etc., adapted to be released from the surface of the cathode in alkaline water and be deposited at the surface of the anode when an electric voltage is applied across the anode and the cathode; and a diaphragm separating the anode and the cathode, wherein the diaphragm is gas tight and is permeable to the anode catalytic material. However, the use of a diaphragm separating the anode and the cathode being permeable to the anode catalytic material may not be advantageous in some electrolytic cells, and the manufacturing method of the electrodes is relatively complex.

A recent Chinese patent application CN 105 244 173 discloses a preparation method for a super-capacitor with transition metal sulfide electrode material, which is simple, convenient and low in cost. The preparation method comprises the steps of cleaning a cut foam metal, and performing a vacuum drying, and then placing the foam metal in a tubular annealing furnace, and performing heating and annealing while hydrogen sulfide gas is continuously introduced, wherein the heating time is 40-50 min., the annealing temperature is 400-500 deg C., and the annealing time is 30-90 min; and continuously introducing the hydrogen sulfide gas after annealing till natural cooling to room temperature, thus obtaining the transition metal sulfide electrode material with a specific microstructure. The method is particular in that heating nickel foam in H₂S (2-10%) to 400 deg C. will create a high-efficient electrode for constructing a super-capacitor. However, this invention is not related to water electrolysis, and furthermore, the obtained bulk sulfidation will create an electrode material that is so brittle that it is impossible to assemble and use the electrode in a functional electrolyser.

Hence, an improved method for manufacturing or producing an electrode for alkaline water electrolysis would be advantageous, and in particular a more efficient and/or reliable method for producing an electrode would be advantageous.

### SUMMARY OF THE INVENTION

Thus, an object of the present invention relates to an improved method for producing an electrode for alkaline water electrolysis.

In particular, it is an object of the present invention to provide an improved method for producing or manufacturing an electrode for alkaline water electrolysis that solves the above-mentioned problems of the prior art with complex manufacturing methods for electrodes for use in alkaline water electrolysis.

Thus, the first aspect of the invention relates to a method for producing an electrode for alkaline electrolysis based on a Ni foam substrate, the method comprising initially providing a nickel (Ni) foam substrate, the method comprising the separate steps of:
S2) performing a sulfiding of said Ni foam substrate, and
S3) optionally repeating, at least one time, said step S2),
resulting in the formation of electrocatalytic active nano-sites comprising Ni—S compounds capable of reducing the overpotential of the electrode during alkaline water electrolysis.

Advantageous, the present invention provides a relative simple and efficient method for producing electrodes, which has the potential to significantly reduce complexity, both with respect to time and cost, in producing electrodes for alkaline electrolysis.

It is found that these Ni—S based nano-sites are capable of reducing the so-called overpotential of the electrodes during alkaline water electrolysis, and the production of electrodes may be significantly simplified. In particular, already existing electrolyzer units may benefit from this invention by on-site application of the improved method, e.g. by applying a sulfur-containing gas for example a H₂S-containing gas to improve the performance of already functional electrolyzer units, a so-called in-situ sulfiding process.

Yet another aspect of the present invention is to provide an electrode for alkaline water electrolysis according to the first aspect.

Yet another aspect of the present invention is to provide an electrolysis system with electrodes according to the first and/or any other aspects for alkaline water electrolysis or other electrochemical applications as mentioned below.

A primary application of the present invention according to any of the above-mentioned aspects relates to improved alkaline electrolysis by providing electrocatalytic active nano-sites. However, it is contemplated and suggested by theoretical considerations that the electrodes and the corresponding method for producing such electrodes may also be beneficially applied in connection with electrodes for Cl₂ production, electrocatalytic production of NH₃ or CO₂ conversion to CO.

### BRIEF DESCRIPTION OF THE FIGURES

FIG. 1 shows an example of reduced overvoltage for hydrogen formation as compared to an untreated Ni reference in a 10 m³/h pilot plant operating at 30 bar,

FIG. 2 shows a Pourbaix diagram for NiTe₂ in the entire pH range from 0 to 14,

FIG. 3 shows a flow chart of the present invention for a method for producing an electrode for alkaline electrolysis,

FIG. 4 shows another flow chart of the present invention for a method for producing an electrode for alkaline electrolysis having preliminary treatment with heating and post-treatment with heating,

FIG. 5 shows a principle drawing of electrolytic deposition of metal in an electrolytic cell where the metal layer is deposited on the cathode,

FIG. 6 shows a principle drawing of an oven heating a nickel foam in a H₂S containing gas to perform sulfiding of the substrate,

FIG. 7 shows three different levels of an electrolysis system according to the present invention; in A) a photograph of an electrolysis configuration is shown based on Ni foam electrodes, where in the enlargement B) the Ni foam on both the anode and the cathode side is schematically illustrated, and the additional enlargement C) shows a schematic illustration of these electrocatalytic active nano-sites on a part of the Ni foam according to the present invention,

FIG. 8, A and B, shows polarisation curves at various temperatures with untreated Ni-foam and in-situ sulfidated Ni-foam,

FIG. 9 shows the effect of sulfiding on Ni foam in 3% H₂S at 75 deg C., where the two left SEM images (high and low magnification) shows the pure Ni surface before sulfiding, whereas the middle and right set of SEM images shows the effect of 1 hours and 2 hours sulfiding, respectively,

FIG. 10 shows an extract of cyclic voltammogram of untreated Ni-foam and ex-situ sulfidated Ni-foam, and

FIG. 11 shows an extract of baseline-corrected linear sweep (LS) voltammogram for untreated Ni-foam and ex-situ sulfidated Ni-foam.

The present invention will now be described in more detail in the following.

### DETAILED DESCRIPTION OF THE INVENTION

Prior to discussing the present invention in further details, the following terms and conventions will first be defined:

In context of the present application, it may be understood that the term ‘electrodes’ is to be interpreted broadly as the skilled person in electrochemistry will readily understand. Thus, electrodes according to the present invention may form part of one, or more, electrolytic cell(s), for example a single electrolytic cell, stacked electrolytic cells, low pressure electrolytic cells, high pressure electrolytic cell, a traditional electrolytic cell, a zero gap electrolytic cell, an electrolytic cell with gas diffusion layers in between, etc.

In context of the present application, it may be understood that the term ‘metal’ is to be interpreted broadly as the skilled person will readily understand, in particular that a metal may comprise impurities to a certain extent under realistic working conditions in production facilities for electrodes, and in particular that some metals may have a certain degree of metal oxide formation, on the surface and/or in the bulk, e.g. iron oxide formation like Fe₂O₃ etc.

In context of the present application, it may be understood that the term metal compounds of the type Ni—S is to be interpreted broadly as the skilled person will readily understand, in particular that various stoichiometry relations between the Ni-metal and the sulfur are possible on the Ni foam substrate. Thus, Ni—S is to be interpreted broadly as Ni_{A}S_{B}, where stoichiometric coefficients A and B may vary over a range over meta-stable and/or thermodynamically stabile compounds depending on the specific condition used in the electrodes and the Ni substrate and being highly dependent on the degree of sulfiding, sulfiding partial pressure as well as the temperature during sulfiding, as the skilled person will readily understand from the below explanations and examples. Thus, these Ni—S compounds may also be referred to as nano structures or nano-compounds. Thus, Ni—S or Ni—S may in the form of α-NiS (alfa-polymorph) and β-NIS (beta-polymorph) forms, and various stoichiometric forms like NIS, NiS₂ (Vaesite), Ni₃S₂ Ni₃S₄, Ni₇S₄, Ni₉S₈, etc. Furthermore, the stoichiometric coefficients A and B may also depend on the surrounding electrolyte (concentration, temperature) and the superimposed electrode voltage.

In context of the present application, it may be understood that the term metal compounds of the type Me1-Me2-S—Ni is to be interpreted broadly as the skilled person will readily understand, in particular that various stoichiometry relations between the Me1 and Me2 and sulfur are possible on the Ni foam substrate. Thus, Me1-Me2-S—Ni is to be interpreted as Me1_{A}-Me2_{B}-S_{C}—Ni, where stoichiometric coefficients A, B and C may vary over a range over meta-stable and/or thermodynamically stabile compounds depending on the specific metals of Me1 and/or Me2 used in the electrodes and being highly dependent on the degree of sulfiding, sulfiding partial pressure as well as the temperature during sulfiding, as the skilled person will readily understand from the below explanations and examples. It is also contemplated that Me1 and/or Me2, both being a metal chosen from the group consisting of Mo, Ni, Co, Fe, and/or W, may—to some extent—form various metal oxides in the Me1-Me2-S—Ni compounds according to the present invention. Thus, if Me1 is iron, a certain amount of the iron may form Fe₂O₃-oxides (Fe₂O₃, Fe₃O₄, Fe(OH)₂ and, Fe(OH)₃) in the electrodes. Similar oxidation or partial oxidation may be seen for other involved metals. In a special case, Me1 and Me2 are the same and the resulting compound Me1-S—Ni is formed on the substrate.

In context of the present application, it may be understood that the term ‘sulfiding’ is generally to be interpreted broadly and refer to any chemical reaction with sulfur to form sulfides, also known as a sulfidation. In US English, the corresponding spelling is sulphiding to form sulphides, etc.

Since the sulfiding step may be based on a sulfur diffusion, e.g. via H₂S gas, and subsequent reaction, it will be possible to document a diffusion-based production process by analysing the sulfur depth profile. If the sulfiding process is based on diffusion, there will be a decreasing sulfur concentration upon going deeper into the electrode incl. the Ni foam substrate or deeper into a deposited metal overlayer. In advantageous embodiments, only on the surface part of the Ni substrate there is performed a sulfidation, which has the advantage of maintaining, at least to a substantial extent, the bulk properties of the Ni substrate, such as strong mechanical properties and relatively high conductivity. Thus, in the context of the present application, it is to be understood that a surface constitute an upper boundary volume or region of the Ni substrate, such as a surface having a depth of about 200, 300, 400, 500 or 1000 nm. Therefore, the concept of performing a sulfiding only of the surface will be readily understood by a skilled person in this technical field. Surface sulfiding will be important to maintain the mechanical properties of the Ni substrate.

Alternatively, sulfur may be added through co-deposition and there will be a relatively more abrupt change in the sulfur concentration profile as a function depth into the electrode coating. A co-deposition will not go into the substrate except if it involves a subsequent heating process where again the S-profile will be more abruptly going down to zero as compare to a diffusional sulfiding process.

Suitable analysis techniques for probing the sulfur depth profile is Rutherford Backscattering Spectrometry (RBS), Focused Ion Beam Scanning Electron Microscope (FIB-SEM) equipped with Energy-dispersive X-ray spectroscopy (EDX/EDS), Glow Discharge Optical Emission Spectroscopy (GDOES) or similar depth resolved elemental analysis techniques as the skilled person will readily understand.

In context of the present application, it may be understood that the term ‘nano-sites’, or nano-compounds, is to be interpreted broadly as the skilled person in surface physics and/or surface chemistry will understand. Thus, the Me1-Me2-S—Ni compounds may form electrocatalytic nano-sites having a characteristic dimension, such as (average) diameter or length scale, of 1-1000 nm, preferably 10-500 nm, more preferably, 20-200 nm. Clearly, if electroplating thicker layers (in optional step1 S1) the active layer may be even thicker after sulfiding in step S2.

### Embodiments

In a first aspect, the invention relates to a method for producing an electrode for alkaline electrolysis based on a Ni foam substrate, the method comprising initially providing a nickel (Ni) foam substrate, the method comprising the separate steps of:
S2) performing a sulfiding of said Ni foam substrate, and
S3) optionally repeating, at least one time, said step S2)
resulting in the formation of electrocatalytic active nano-sites comprising Ni—S compounds capable of reducing the overpotential of the electrode during alkaline water electrolysis. It is contemplated—without being bound to any specific theory—that one factor explaining this is an increase in the effective surface area giving more electrocatalytic active nano-sites.

Furthermore, an optional step S1) metal deposition may be performed prior to the sulfiding step S2), preferably by electroplating, the metal being Mo, Ni, Co, Fe, and/or W, on said Ni foam substrate resulting in a metal-S—Ni compound being formed on and/or in the Ni foam substrate. Thus, the invention may also be combined with so-called in-situ metal deposition, for e.g. upgrading existing electrolyzer unit with metal deposition or plating and subsequent in-situ sulfiding.

It is also contemplated that the invention may be combined with an optional step S1) metal deposition that may be performed after the sulfiding step S2), preferably by electroplating, the metal being Mo, Ni, Co, Fe, and/or W, on said Ni foam substrate resulting in a metal-S—Ni compound being formed on and/or in the Ni foam substrate.

It is contemplated that the method for producing an electrode is related to the electrocatalytic active nano-sites comprising Ni—S compounds being capable of reducing the overpotential of the electrode during alkaline water electrolysis at least 0.1 V, optionally 0.2 V, preferably at least 0.3 V, more preferably at least 0.4 V, at a minimum current density of 0.2 A/cm². This is documented for temperatures around 20 deg C. and 60 deg C., but the effect is believed to be present for a broad range of temperatures.

In other embodiments, the method for producing an electrode is related to the formation of electrocatalytic active nano-sites comprising Ni—S compounds being capable of reducing the overpotential of the electrode during alkaline water electrolysis by an increased surface area of said nano-sites.

In yet other embodiments, the method for producing an electrode is related to the formation of electrocatalytic active nano-sites comprising Ni—S compounds being capable of reducing the overpotential of the electrode during alkaline water electrolysis by reducing the absolute binding energy of hydrogen on said nano-sites.

In other embodiments, the method for producing an electrode is related to the formation of electrocatalytic active nano-sites comprising Ni—S compounds being capable of reducing the overpotential of the electrode during alkaline water electrolysis by reducing the absolute binding energy of oxygen on said nano-sites.

In further embodiments, the method for producing an electrode is related to the formation of electrocatalytic active nano-sites comprising Ni—S compounds being capable of reducing the overpotential of the electrode during alkaline water electrolysis by modifying the bubble formation and/or desorption of hydrogen formed on said nano-sites.

In additional embodiments, the method for producing an electrode may be related to the formation of electrocatalytic active nano-sites comprising Ni—S compounds being capable of reducing the overpotential of the electrode during alkaline water electrolysis by modifying the bubble formation and/or desorption of oxygen formed on said nano-sites.

In supplementary embodiments, the method for producing an electrode is related to the formation of electrocatalytic active nano-sites comprising Ni—S compounds being capable of reducing the overpotential of the electrode during alkaline water electrolysis by decreasing the on-set voltage for hydrogen formation.

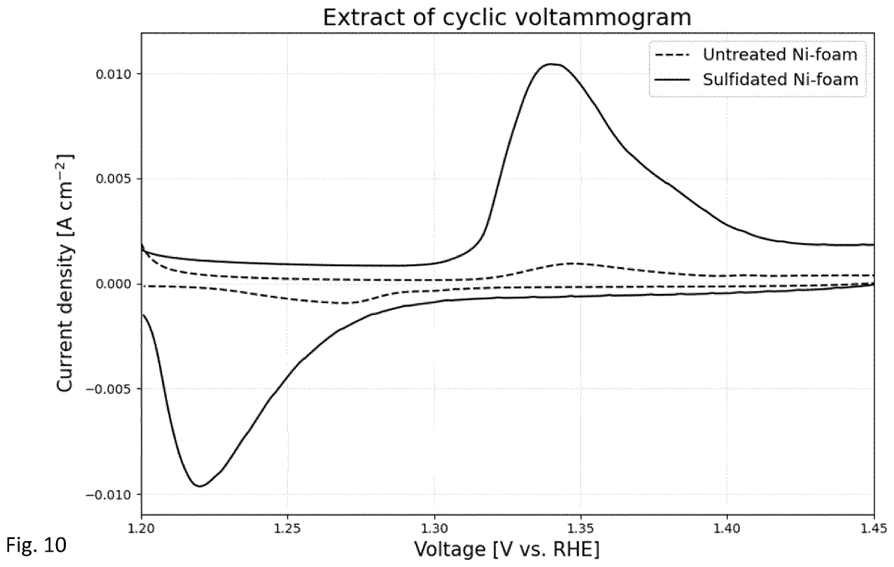

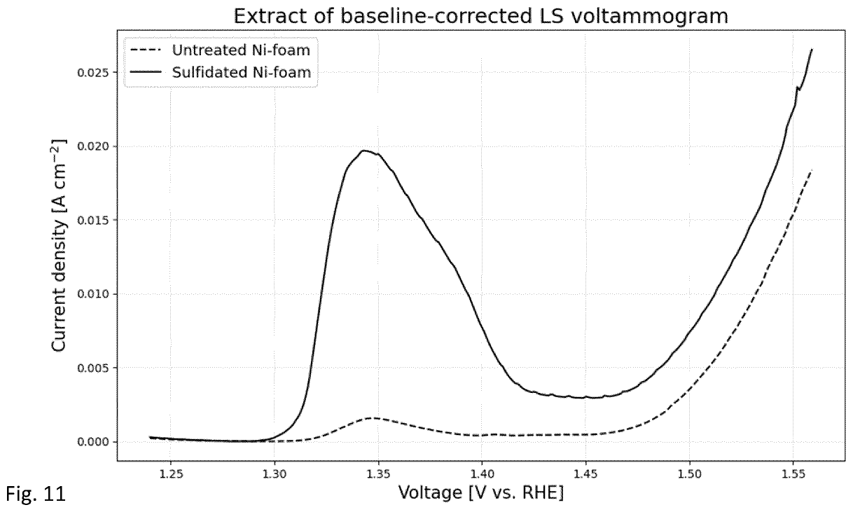

In yet additional embodiments, the method for producing an electrode may be related to the formation of electrocatalytic active nano-sites comprising Ni—S compounds being capable of reducing the overpotential of the electrode during alkaline water electrolysis by decreasing the on-set voltage for oxygen formation. This is made very likely by results provided by the inventors, cf. FIGS. 10 and 11 below.

In yet additional embodiments, the method for producing an electrode is related to the formation of electrocatalytic active nano-sites comprising Ni—S compounds being capable of reducing the overpotential of the electrode during alkaline water electrolysis by facilitating more nano-sites that can be oxidized for generating Ni-oxide-nano-sites beneficial for oxygen formation. This is documented by results provided by the inventors, cf. FIGS. 10 and 11 below.

In other embodiments, the method for producing an electrode may be related to sulfiding of said Ni foam substrate being performed at a temperature interval of approximately 20-150ºC, preferably at a temperature interval of approximately 50-100ºC, most preferably at a temperature interval of approximately 70-80° C.

In additional embodiments, the method for producing may be related to the sulfiding of said Ni foam substrate being performed with a gas composition, preferably with minimum pressure of about 0.5 atm., 1 atm., 2 atm., 3 atm., 4 atm. or 5 atm. Other possible pressure ranges and minimum values are also contemplated within the context of the present invention.

In other additional embodiments, the method for producing may be related to an electrode the sulfiding of said Ni foam substrate being performed with a gas composition with relative volume part of water being in the interval of approximately 0.1-20%, preferably in the interval of approximately 5-15%, more preferably around 10%, 20%, 30%, 40%, 50%, 60%, 70%, 80%, 90%, or 100%.

In yet additional embodiments, the method for producing an electrode may be related to the electrode for alkaline electrolysis being based on a Ni foam substrate, which is an anode part and/or the cathode part.

In other additional embodiments, the method for producing an electrode may be related to the sulfiding being performed in less than 10 hours, preferably less than 5 hours, most preferably less than 2 hours. Clearly, this will also be intertwined with the sulfiding temperature and sulfur partial pressure.

In other embodiments, the method for producing an electrode, wherein the electrode produced is part of an existing electrolysis system. Thus, the method for producing an electrode may be performed as an improvement of an already existing electrode forming part of an electrolyzer unit, a so-called in-situ sulfiding taking place in the electrolyzer unit(s).

In other embodiments, the method for producing an electrode may related to a pre-treatment being performed before the sulfiding of said Ni foam, said pre-treatment comprising:
heating in a non-wetting atmosphere, for example with pure N₂, Ar, or other inert gasses, or
heating in a humid atmosphere, preferably with relative humidity of 1 to 20 vol. procent, preferably 2-10 vol. procent.

During such pre-treatment, it is to be understood by the skilled person in electrochemistry that the impact on the membrane, i.e. the gas separating membrane, should be considered in view of any such pre-treatments with the perspective of minimizing or reducing any negative impact so as to conserve this membrane.

In yet other embodiments, the method for producing an electrode may be related to the step S2) of sulfiding on said Ni compound being performed with a sulfiding medium comprising hydrogen sulfide, H₂S, alternatively dimethyl sulfide (DMS), dimethyl sulfoxide (DMSO, (CH₃)₂SO), Ethyl Mercaptan (CH₃CH₂SH), Butyl Mercaptan (C₄H₁₀S), thiourea, C₂S₂ or H₂S₂.

In some other embodiments, the method for producing an electrode may be related to the sulfiding of said Ni foam substrate being performed with a gas composition, optionally a H₂S gas, preferably with a gas composition of 1-10 vol. % H₂S, more preferably 2-4 vol. % H₂S, most preferably around 3 vol. % H₂S. Though other compositions of H₂S gas such as around 20, 30, 40, 50, 60, 70, 80, 90 or 100 vol. % etc. are also contemplated as suitable within the context of the present invention.

In other embodiments, the method for producing an electrode may be related to the Ni foam being replaced by a foam (or woven structure, or a plate, or a mesh) from any of the metals chosen from the group consisting of Fe, Co, Cr, and/or Cu. Still further the Ni foam may be replaced by a Ni woven structure, a Ni plate, or a Ni mesh.

In yet other embodiments, the method for producing an electrode may comprise an additional heating step, which may be performed as:
S_Pre) before optional step S1) metal deposition,
S_Inter) between optional S1) metal deposition and S2) sulfiding, and/or
S_Post) after S2) sulfiding, and any combinations thereof.

In another aspect, the invention relates to an electrode manufactured according to the method of the first aspect. The skilled person in electrochemistry will readily understand that the various steps for producing a new and advantage electrode may swiftly be implemented in an electrode.

In yet another aspect, the invention relates to an electrolysis system comprising one or more electrodes manufactured according to the method of the first aspect. Again, the skilled person in electrochemistry will readily understand that the various step for producing a new and advantage electrode may swiftly be implemented in an electrolysis system, for example with several electrolyzer units.

According to literature, there are potential improvements by different steps in the catalyst formulation. The impregnation of Ni prior to Co results in higher dispersion of molybdenum. The tri-metallic catalyst Co—NiMo/Y—Al₂O₃ synthesized has been observed to have a higher hydrodesulfurization (HDS) and hydrodenitrogenation (HDN) activity as compared to that shown by bimetallic catalysts. The higher activity shown by tri-metallic CoNiMo catalysts may be ascribed to the double promotional effect of Co and Ni and formation of three types of active phases NiMOS, CoMOS and Ni-CoMOS, cf. Effect of synthesis technique on the activity of CoNiMo tri-metallic catalyst for hydrotreating of heavy gas oil, Catalysis Today, Volume 291, 1 Aug. 2017, Pages 160-171. Hence, it can be expected that any Ni—S sites are very active for hydrogen formation.

In another embodiment, the method for producing an electrode according to the first aspect relates to a metal deposition, where optional step S1) is performed by electroplating, preferably DC electroplating, pulse electroplating or ionic electroplating, or any combinations thereof. Other alternatives contemplated: PVD (DC sputtering, RF sputtering, HiPIMS, pulse DC, etc.), CVD processes, various types of thermal spraying, electroplating (DC, pulse plating or ionic plating). Liquid infiltration followed by calcination, etc., as will readily be understood by the skilled person once the teaching and principle of the present invention is fully comprehended. In FIG. 5, a conventional electroplating is schematically indicated. The metal source for the coating is supplied by the two anodes (+) as well as by the metal ions in the bath. The energy is supplied by an external power supply (not shown). The metal layer is then deposited at the cathode (−).

In another embodiment, the method for producing an electrode according to the first aspect, a step S2) of sulfiding on said metal-Ni compound may be performed with a sulfiding medium comprising hydrogen sulfide, H₂S, alternatively dimethyl sulfide (DMS), dimethyl sulfoxide (DMSO, (CH₃)₂SO), Ethyl Mercaptan (CH₃CH₂SH), Butyl Mercaptan (C₄H₁₀S), thiourea, C₂S₂ or H₂S₂. It is also contemplated that heating in packed bed with S-containing granulates or elemental sulfur may be beneficially applied in the present invention.

In advantageous embodiments, the method for producing an electrode according to the first aspect may relate to the Ni foam being replaced by a foam from any of the metals chosen from the group consisting of Fe, Co, Cr, and Cu.

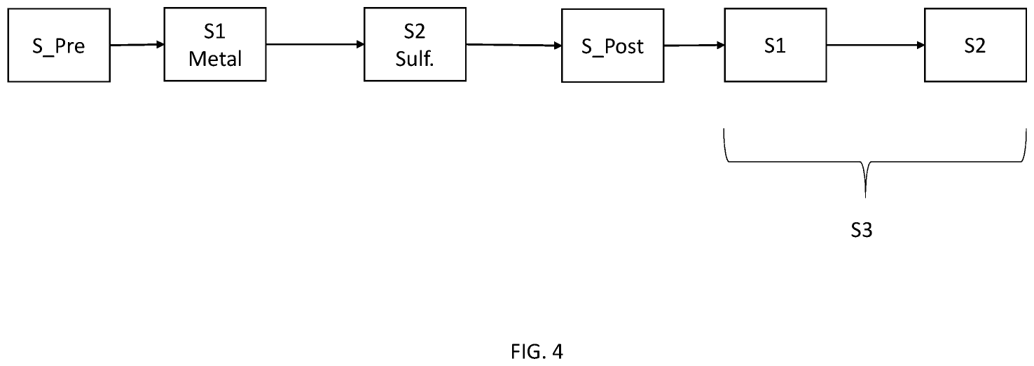

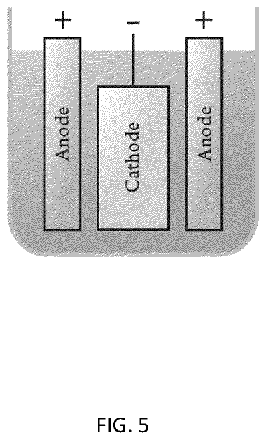

In useful embodiments, the method for producing an electrode according to the first aspect may relate to an additional heating step being performed at various positions in the overall process according to the present invention:
S_Pre) before optional step S1) metal deposition,
S_Inter) between optional S1) metal deposition and S2) sulfiding, and/or
S_Post) after S2) sulfiding, and any combinations thereof.
   as will be explained in more detail below, cf. FIG. 4.

In advantageous embodiments, the method for producing an electrode according to the first aspect may relate to optional step S1), in an initial execution, being omitted thereby resulting in step S2 being a pre-sulfiding step of the Ni foam substrate.

In advantageous embodiments, the electrocatalytic active nano-sites may comprise Ni—S compounds or Me1-Me2-S—Ni compounds capable of reducing the overpotential of the electrode during alkaline water electrolysis comprises primarily edge sites situated on the edge of the said nano-sites. Thus, the Haldor Topsøe research team has together with Aarhus university and DTU in Denmark verified both experimentally and theoretically the existence of very active “BRIM® sites”, at the edges of the molybdenum disulfide nanocrystals. These edge sites with and without the presence of Ni/Co-edge atoms are believed to highly catalytic active sites for HDN and HDS. These sites interact with hydrogen and may also be very active in connection with alkaline electrolysis, cf. Atomic-Scale Structure of Co(Ni)—Mo—S Nanoclusters in Hydrotreating Catalysts, J. V. Lauritsen, S. Helveg, E. Lægsgaard, I. Stensgaard, B. S. Clausen, H. Topsøe, F. Besenbacher, Journal of Catalysis, Volume 197, Issue 1, 1 Jan. 2001, Pages 1-5.

Hence, it is very likely that undercoordinated Ni—S—, Co—S—, Co—Mo—S—, or Ni—Mo—S sites will be very active for hydrogen formation in alkaline electrolysis.

In other advantageous embodiments, the electrocatalytic active nano-sites may comprise Ni—S compounds or Me1-Me2-S—Ni compounds capable of reducing the overpotential of the electrode during alkaline water electrolysis comprising primarily sulfur deficient sites with near metallic properties. Thus, the reactivity and the ability to lower the voltage for hydrogen formation might be related to the degree of sulfur vacancies (sulfur deficient sites).

In advantageous embodiments of in an optional step S1), metal deposition is performed prior to the sulfiding step S2), preferably by electroplating, the metal being Mo, Ni, Co, Fe, and/or W, on said Ni foam substrate resulting in a metal-Ni compound being formed on and/or in the Ni foam substrate.

It should be noted that embodiments and features described in the context of one of the aspects of the present invention also apply to the other aspects of the invention.

All patent and non-patent references cited in the present application are hereby incorporated by reference in their entirety.

The invention will now be described in further details in the following non-limiting examples.

### Example 1: Lowering of the Overpotential for Hydrogen Formation in Alkaline Electrolysis

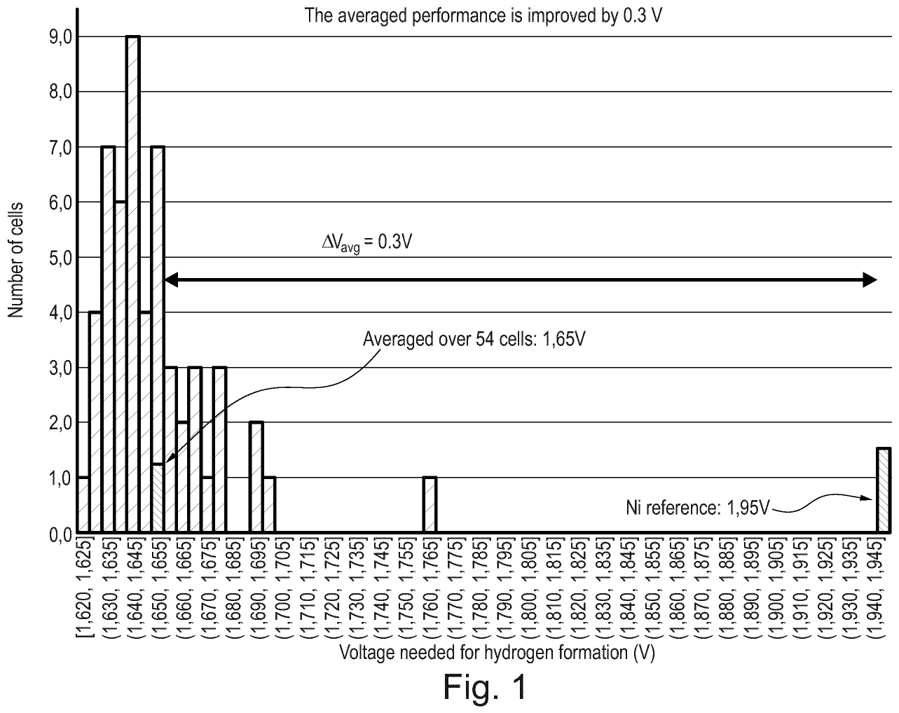

EP 0 235 860 covers a method for manufacturing an electrode for making H₂ and O₂ in an alkaline media, which comprises electro-deposition a catalytic layer which contains at least Ni and S, on an electrical-conducting substrate. Following the ideas outlined in EP 0 235 860 electroplating with suitable Ni-salts and suitable sulfur-releasing agents the present inventors fabricated and assembled 54 electrodes Ø60 in an alkaline pilot electrolysis unit. As seen in FIG. 1, the voltage for hydrogen formation was on the average lowered by 0.3V as compared to an untreated Ni reference. The best performing electrode lowered the voltage for hydrogen formation with 0.33V.

FIG. 1 shows on the left a histogram over 54 Ø60 cm electrodes showing the number of electrodes generating hydrogen in a specific voltage interval. Each interval is 0.005V. On the average, the voltage for hydrogen formation is lowered by 0.3V as compared to the red untreated nickel reference, which generates hydrogen at 1.95V. The best electrode needs only 1.62V for hydrogen formation corresponding to a decrease of 0.33V for hydrogen formation.

### Example 2: Thermodynamic Stability of Different Metal Sulfides Under Alkaline Electrolysis Conditions

Table 1 and Table 2 below shows the calculated delta G value for the following two reactions:

MoS₂+4 KOH=MoO₂+2 H₂O+2 K₂S (i)

WS₂+4 KOH=WO₂+2 H₂O+2 K₂S (ii)

TABLE 1
The predicted stability of MoS₂ under KOH conditions. As evident
from the calculated positive Delta G value, it is not possible
to decompose MoS₂ in a KOH solution below 100° C.
MoS₂ + 4KOH = MoO₂ + 2H₂O + 2K₂S

| T(° C.) | Delta G (kcal) |
|---|---|
| 0 | 12,539 |
| 10 | 12,473 |
| 20 | 12,405 |
| 30 | 12,335 |
| 40 | 12,265 |
| 50 | 12,194 |
| 60 | 12,121 |
| 70 | 12,048 |
| 80 | 11,974 |
| 90 | 11,899 |
| 100 | 11,824 |

TABLE 2
The predicted stability of WS₂ under KOH conditions. As evident
from the calculated positive Delta G value, it is not possible
to decompose WS₂ in a KOH solution below 100° C.
WS₂ + 4KOH = WO₂ + 2H₂O + 2K₂S

| T(° C.) | Delta G (kcal) |
|---|---|
| 0 | 8,266 |
| 10 | 8,195 |
| 20 | 8,123 |
| 30 | 8,049 |
| 40 | 7,975 |
| 50 | 7,899 |
| 60 | 7,823 |
| 70 | 7,745 |
| 80 | 7,667 |
| 90 | 7,588 |
| 100 | 7,508 |

From the calculated positive delta G values, it can be concluded that it is not thermodynamically possible below 100° ° C. to transform MoS₂ or WS₂ to the corresponding oxides (MoO₂ or WO₂) in the presence of KOH. Hence, it can be concluded that MoS₂ and WS₂ are stable under typical conditions used in alkaline electrolysis (20-30% KOH and 90° ° C.).

### Example 3: Calculated Stability of Metal Tellurides

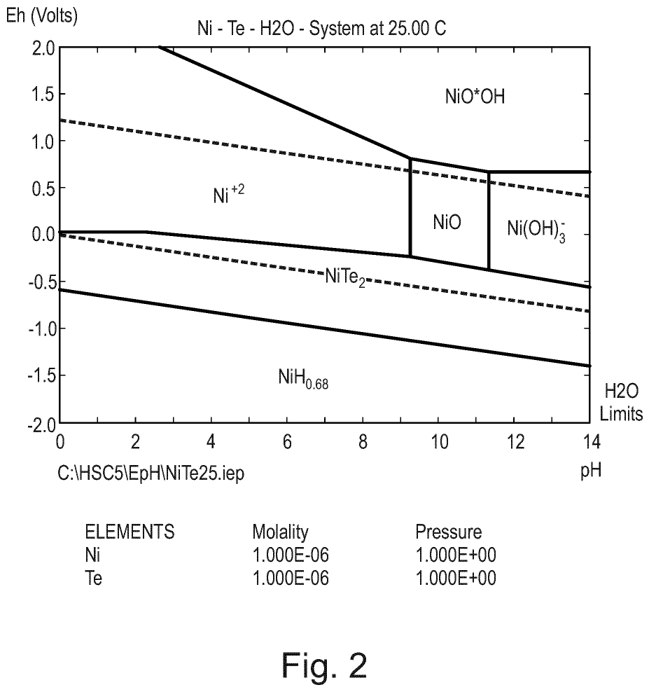

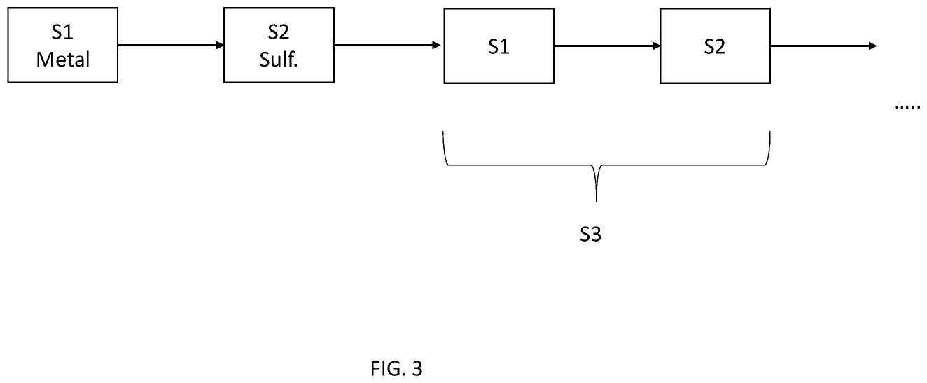

FIG. 2 shows a Pourbaix diagram indicating that NiTe₂ is stable under the hydrogen formation line in the entire pH range from 0 to 14 which makes it very suitable as electrode material on the cathode side.

As can be seen from the Pourbaix diagram in FIG. 2, NiTe₂ is stable in the entire pH-range, below the stability area of water where water is forming hydrogen (the lower dashed line). This implies that NiTe₂ is stable in the environment relevant for alkaline electrolysis as a hydrogen-forming cathode. Thus, in one aspect of the invention sulfur may be replaced with tellur.

### Example 4: Stable Co—Mo—S—, Ni—Mo—S—, Co—Ni—Mo—S, Co—W—S—, Ni—W—S— and/or Co—Ni—W—S-Sites for Hydrogen Formation

Nan Topsøe and Henrik Topsøe were the first to identify the active Co—Mo—S—, Ni—Mo—S— and Co—Ni—Mo—S-sites on sulfided catalysts for hydrodesulfurization (HDS) and hydrodenitrogenation (HDN) [A, B]. Over the years the Topsøe group has shown that the density of these active Co—Mo—S—, Ni—Mo—S— and Co—Ni—Mo—S-sites can be quantified by NO or CO adsorption, and furthermore, that the concentration of these edge sites on sulfided Co/Ni—MoS₂ catalysts can be correlated with the overall catalytic activity [C]. The catalysts are often made by pore filling of γ-Al₂O₃ or a suitable zeolite system with Mo, W, Ni and/or Co, in one or more steps, followed by calcination forming γ-Al₂O₃ or zeolite supported mixed oxide systems. The mixed oxides are subsequently sulfided in e.g. H₂S to obtain active HDN/HDS catalysts.

The uniqueness of the Co—Mo—S—, Ni—Mo—S—, Co—Ni—Mo—S, Co—W—S—, Ni—W—S—, Co—Ni—W—S-sites formed at the edges of MoS₂/WS₂ clusters has been further supported by Density-functional theory (DFT) calculations [D, E]. Topsøe et al. has suggested that these sites are promoting good hydrogenation properties with unique hydrogen interaction.

Hence, the present patent application suggests to synthesis Co—S, Ni—S, Co—Mo—S—, Ni—Mo—S—, Co—Ni—Mo—S, Co—W—S—, Ni—W—S— and/or Co—Ni—W—S-sites on nickel foam substrate by the suggested step1/step2 procedure or combination of several step1's/step2's forming active electrodes for alkaline electrolysis.

Especially as the unique activity is associated with sulfur deficient sites approaching a metallic nature which is expected to be highly active/beneficial for the formation of hydrogen at a lower voltage in alkaline environments [E, F].

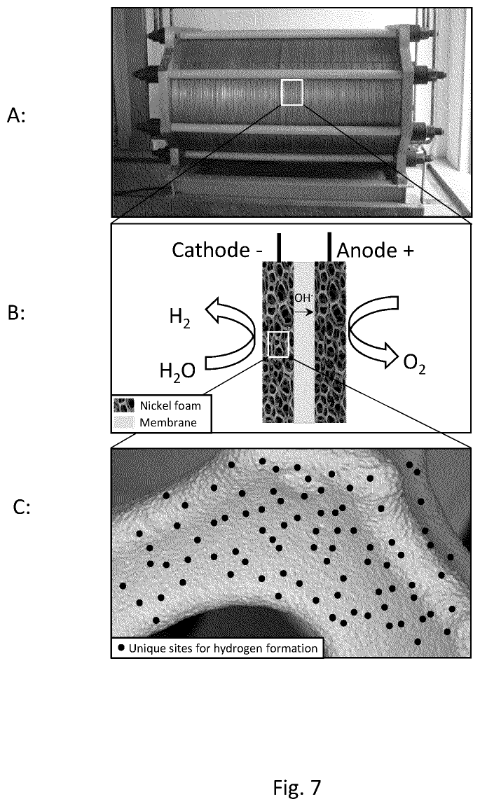

FIG. 7 C) shows a schematic illustration of these proposed unique eletrocatalytic sites on a section of Ni foam according to the invention for hydrogen formation in the lower third section. The suggested electrodes may also be used on the anode side. In the middle B) section, the Ni foam on both the anode and the cathode side is schematically illustrated with a membrane where OH— can be transported. In section A), a photograph of an electrolysis configuration is shown based on Ni foam electrodes.

### Example 5: Direct Heating of Ni Foam in H₂S

In one embodiment of the present invention, a nickel foam may be heated in a H₂S containing atmosphere converting the Ni-substrate (+surface oxidized substrate (NiO)) into a Ni—S phase. Depending on how extensive the sulfiding process should be, it may be necessary to heat to higher temperatures. However, it should be kept in mind that bulk sulfiding should be avoided since this will create a very brittle and mechanically unstable substrate. The temperature should be preferentially below 200° C. Thus, some experiments suggest that maximum temperatures of about 75, 90, 100, 150, 200 degrees C. may be sufficient for performing the sulfiding process step S2. This is favorable for practical implementation, saves energy, and minimizes the possible negative impact of heating the electrode unnecessary. Time is of course also a relevant factor as the skilled person in surface chemistry will readily understand, such process time of sulfiding may be 5, 10, 15, 20, 30, or 40 hours of maximum treatment time, though it naturally also depends on the flow of H₂S and the H₂S concentration.

### Example 6: Coating of Nickel Foam with e.g. Mo Followed by Heating in H₂S

In one embodiment of the invention, a nickel foam may be electroplated by e.g. Mo (or other metals) followed be heated in a H₂S containing atmosphere converting part of the Ni-substrate (+surface oxidized substrate (NiO)) and the plated Mo into a Mo—S/NiMOS phase. Depending on how extensive the sulfiding process should be, it will be necessary to heat to higher temperatures. However, it should be kept in mind that bulk sulfiding should be avoided since this will create a very brittle and mechanically unstable substrate. The temperature should be preferentially below 200° C. Thus, some experiments suggest that maximum temperatures of about 75, 90, 100, 150, 200 degrees C. may be sufficient for performing the sulfiding process step S2. This is favorable for practical implementation, saves energy, and minimizes the possible negative impact of heating the electrode unnecessary as mentioned above.

### Example 7: Example 6 Followed by Ni and/or Co Coating and Heating in H₂S

Examples 6 might also be followed by electroplating with Ni and/or Co after Mo coating or after Mo coating and heating in H₂S to create CoMOS and NiMOS sites. Depending on how extensive the sulfiding process should be, it will be necessary to heat to higher temperatures. However, it should be kept in mind that bulk sulfiding should be avoided since this will create a very brittle and mechanically unstable substrate. The temperature should be preferentially below 200° C.

### Example 8: Example 5-7 Involving Pre- and/or Post-Treatments

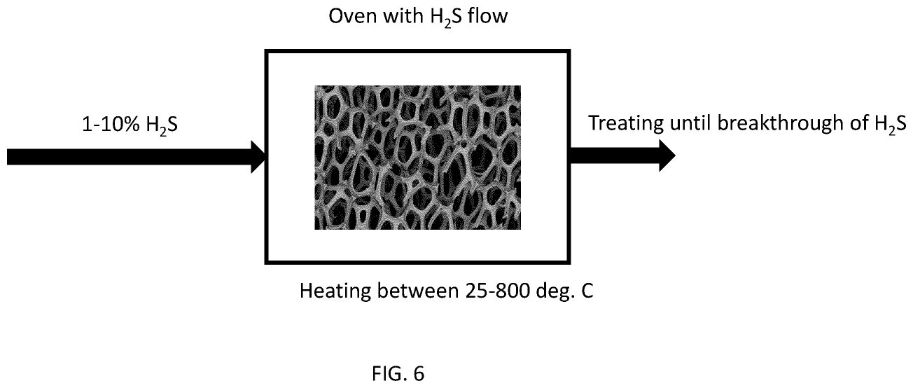

Example 5-7 might be combined with any pre- and/or post-treatments involve e.g. heating in air converting metal to metal oxides before sulfiding in H₂S. Depending on the degree of oxidation, it will be necessary to heat to higher temperatures. However, it should be kept in mind that bulk sulfiding should be avoided since this will create a very brittle and mechanically unstable substrate. The temperature should be preferentially below 200° C. For example, FIG. 4 shows pre-treatment S_Pre with heating following by S1 (for example metal electroplating) and S2 (for example sulfiding by H₂S treatment shown in FIG. 6), where post-treatment S_Post with heating is followed by a first repeating of optional S1 and S2, the repeating being name S3.

In FIG. 6, a sulfiding is performed in a heated oven, where a flow of H₂S containing gas in various concentration, such as 1-10%, is flowing through the Ni foam substrate. The sulfiding may be considered completed from a practical point of view when the gas is flowing through the Ni foam as schematically indicated to the right in FIG. 6 end there is no longer any H₂S consumption.

### Example 9: Example 5-8 Including Additional Steps of the Step1 and/or Step2 Types

In another embodiment of the proposed production of electrodes one might combine example 5-9 with any other number of optional Step 1 (S1) and/or Step 2 (S2) including one or more post-/pre-treatments/intermediate treatments and permutations hereof, as for example shown in FIG. 4.

### Example 10: Example 5-9 Including Other Metals

Other metals such as Cr, Fe, and/or Cu could be applied, and instead of sulfiding step2 could involve Se or Te as explained above.

### Example 11: In-Situ Sulfiding of an Electrolyzer Unit

An electrolyzer unite comprises a number of cells containing a bipolar plate, an anode electrode, a gas separating membrane, a cathode electrode and a bipolar plate. After this another cell is starting using the previous bipolar plate, i.e. continue with an anode electrode, a membrane, a cathode electrode and a bipolar plates and vice versa.

Typically, the membrane is made of a woven material comprising a polymeric material and ZrO₂ particles. In the case of AGFA (e.g. ZIRFON UTP 220) it is composed by an open mesh of polyphenylene sulfide fabric which is symmetrically coated with a mixture of a polymer and zirconium oxide.

In one embodiment of the invention Ni-foam is sulfided by e.g. H₂S, e.g. H₂S gas, in-situ in an assembled electrolyzer unit. i.e. containing multiple cells of both the anode and the cathode as well as the gas separating membrane.

As evident from the thermodynamic calculations below the conversion of ZrO₂ particles in the membrane to ZrS₂ particle is thermodynamically impossible since Gibbs free energy is positive. On the contrary, NiO is easily converted to NiS since the Gibbs free energy is negative. Hence, the anode or cathode or both are sulfided by H₂S whereas this is not possible for the gas separating membrane.

TABLE 3
Gibbs free energy as a function of temperature for the
ZrO₂ + 2H₂S(g) = ZrS₂ + 2H₂O(g) reaction. Since
Gibbs free energy is positive it is not possible to
convert ZrO₂ particles to ZrS₂.
ZrO₂ + 2H₂S(g) = ZrS₂ + 2H₂O(g)

| T (° C.) | ΔG (kcal) |
|---|---|
| 0 | 19.680 |
| 50 | 19.755 |
| 100 | 19.812 |
| 150 | 19.860 |
| 200 | 19.904 |
| 250 | 19.947 |
| 300 | 19.991 |
| 350 | 20.036 |
| 400 | 20.085 |
| 450 | 20.138 |
| 500 | 20.195 |

TABLE 4
Gibbs free energy as a function of temperature for the
NiO + H₂S(g) = NiS + H₂O reaction. Since Gibbs
free energy is negative it is not possible to convert
NiO to NiS.
NiO + H₂S(g) = NiS + H₂O

| T (° C.) | ΔG (kcal) |
|---|---|
| 0 | −19.247 |
| 50 | −17.802 |
| 100 | −16.441 |
| 150 | −15.148 |
| 200 | −13.911 |
| 250 | −12.723 |
| 300 | −11.584 |
| 350 | −10.512 |
| 400 | −9.566 |
| 450 | −8.758 |
| 500 | −8.015 |

Hence, the present invention can use the assemblies electrolyzer unit as an oven sulfiding the anode or the cathode or both without destroying the gas separating membrane between the anode and the cathode.

### Example 12 In-Situ Sulfiding

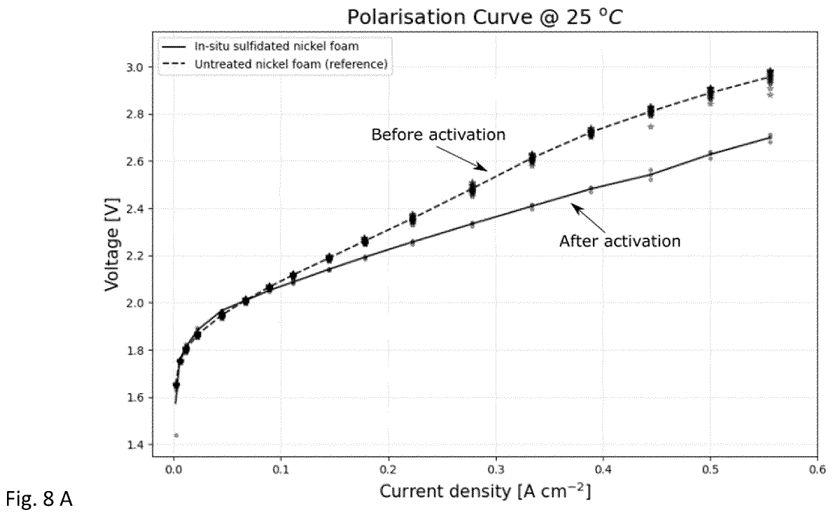

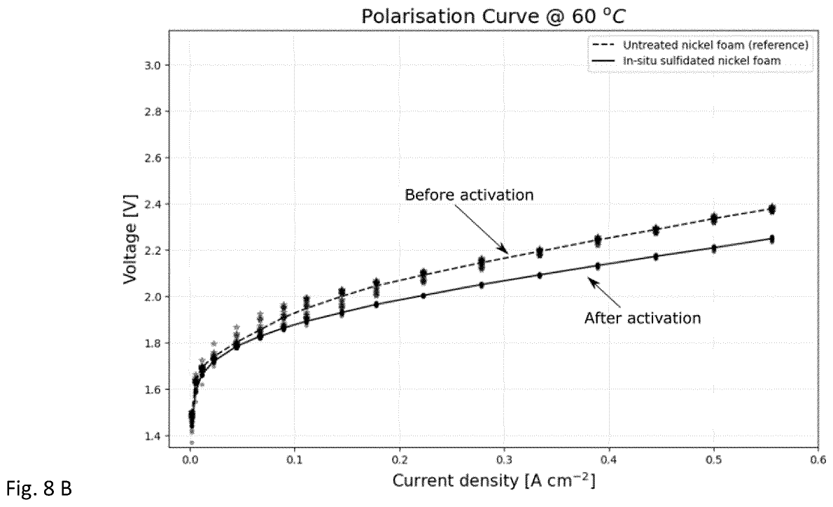

FIG. 8 shows polarisation curves at various temperatures with untreated Ni-foam (reference) and in-situ sulfidated Ni-foam.

From the figure it is seen that hydrogen can be formed at a lower potential after in-situ sulfiding illustrating that the overpotential for hydrogen/oxygen is reduced by the in-situ sulfiding process, i.e. there is clearly performed an activation by sulfiding the Ni foam as also explained in the graph.

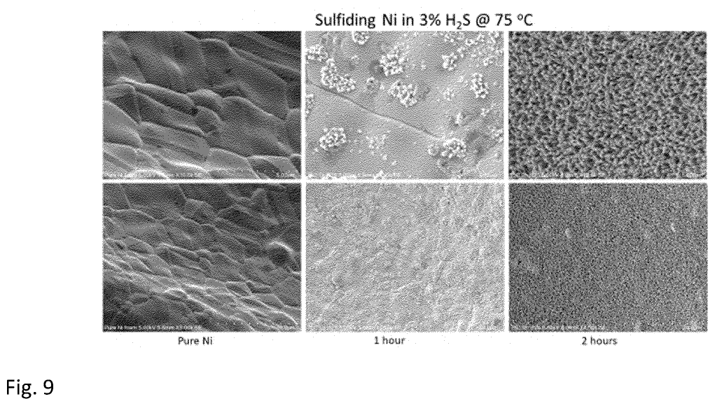

FIG. 9 shows the effect of sulfiding on Ni foam in 3% H₂S at 75 deg C., where the two left SEM images (high and low magnification) shows the pure Ni surface before sulfiding, whereas the middle and right set of SEM images shows the effect of 1 hours and 2 hours sulfiding, respectively.

### Example 13

FIG. 10 shows an extract of cyclic voltammogram at various temperatures with untreated Ni-foam and in-situ sulfidated Ni-foam.

FIG. 11 shows an extract of baseline-corrected linear sweep (LS) voltammogram at various temperatures with untreated Ni-foam and in-situ sulfidated Ni-foam.

Both figures of this example are baseline corrected to remove the contribution from capacitive current.

FIGS. 9, 10 and 11 support that for the present invention i.e. a method for producing an electrode where the formation of electrocatalytic active nano-sites comprising Ni—S compounds being capable of reducing the overpotential of the electrode during alkaline water electrolysis by decreasing the on-set voltage for oxygen formation. The figures also support that the formation of electrocatalytic active nano-sites comprising Ni—S compounds being capable of reducing the overpotential of the electrode during alkaline water electrolysis by facilitating more nano-sites that can be oxidized for generating Ni-oxide-nano-sites beneficial for oxygen formation.

### REFERENCES

[A] N. Y. Topsøe & H. Topsøe, Adsorption studies on hydrodesulfurization catalysts. Infrared and volumetric study of NO adsorption on alumina-supported Co, Mo, and Co—Mo catalysts in their calcined state. Journal of Catalysis 75(1982), 354-374.
[B] N. Y. Topsøe & H. Topsøe, Characterization of the structures and active-sites in sulfided Co—Mo/Al₂O₃ and Ni—Mo/Al₂O₃ catalysts by No chemisorption. Journal of Catalysis 84(1983) 386-401.
[C] H. Topsøe, B. S. Clausen & F. E. Massoth, Hydrotreating Catalysis Vol. 11 (Springer Verlag, 1996).
[D] Poul Georg Moses, Berit Hinnemann, Henrik Topsøe, Jens K. Nørskov, Spectroscopy, microscopy and theoretical study of NO adsorption on MoS₂, Journal of Catalysis Volume 268(2009)201-208.
[E] H. Topsøe, The role of Co—Mo—S type structures in hydrotreating catalysts, Applied Catalysis A: Volume 322(2007), 3-8.
[F] Nan-Yu Topsøe, Anders Tuxen, Berit Hinnemann, Jeppe V. Lauritsen, Kim G. Knudsen, Flemming Besenbacher, Henrik Topsøe, Spectroscopy, microscopy and theoretical study of NO adsorption on MoS₂ and Co—Mo—S hydrotreating catalysts, Journal of Catalysis, 279(2011)337-351.

In short, the present invention relates to a method for producing an electrode for alkaline electrolysis based on a composition of sulfides on a Ni foam substrate. In a step, S2) there is performed a sulfiding on the Ni substrate. The step of sulfiding results in the formation of electrocatalytic active nano-sites with Ni—S compounds. It is found that these nano-sites are capable of reducing the so-called overpotential of the electrodes during alkaline water electrolysis, and the production of electrodes may be significantly simplified. In particular, already existing electrolyzer units may benefit from this invention by on-site application of the improved method.

1. A method for producing an electrode for alkaline electrolysis based on a Ni foam substrate, the method comprising initially providing a nickel (Ni) foam substrate, the method comprising the separate steps of:
S2) performing a sulfiding of said Ni foam substrate, and
S3) optionally repeating, at least one time, said step S2),
resulting in the formation of electrocatalytic active nano-sites comprising Ni—S compounds capable of reducing the overpotential of the electrode during alkaline water electrolysis.

2. The method for producing an electrode according to claim 1, wherein a step S1) metal deposition is performed prior to the sulfiding step S2), preferably by electroplating, the metal being Mo, Ni, Co, Fe, and/or W, on said Ni foam substrate resulting in a metal-S—Ni compound being formed on and/or in the Ni foam substrate.

3. The method for producing an electrode according to claim 1, wherein the electrocatalytic active nano-sites comprising Ni—S compounds are capable of reducing the overpotential of the electrode during alkaline water electrolysis at least 0.1 V, optionally 0.2 V, preferably at least 0.3 V, more preferably at least 0.4 V, at a minimum current density of 0.2 A/cm².

4. The method for producing an electrode according to claim 1, wherein the formation of electrocatalytic active nano-sites comprising Ni—S compounds capable of reducing the overpotential of the electrode during alkaline water electrolysis by an increased surface area of said nano-sites.

5. The method for producing an electrode according to claim 1, wherein the formation of electrocatalytic active nano-sites comprising Ni—S compounds capable of reducing the overpotential of the electrode during alkaline water electrolysis by reducing the absolute binding energy of hydrogen on said nano-sites.

6. The method for producing an electrode according to claim 1, wherein the formation of electrocatalytic active nano-sites comprising Ni—S compounds capable of reducing the overpotential of the electrode during alkaline water electrolysis by reducing the absolute binding energy of oxygen on said nano-sites.

7. The method for producing an electrode according to claim 1, wherein the formation of electrocatalytic active nano-sites comprising Ni—S compounds capable of reducing the overpotential of the electrode during alkaline water electrolysis by modifying the bubble formation and/or desorption of hydrogen formed on said nano-sites.

8. The method for producing an electrode according to claim 1, wherein the formation of electrocatalytic active nano-sites comprising Ni—S compounds capable of reducing the overpotential of the electrode during alkaline water electrolysis by modifying the bubble formation and/or desorption of oxygen formed on said nano-sites.

9. The method for producing an electrode according to claim 1, wherein the formation of electrocatalytic active nano-sites comprising Ni—S compounds capable of reducing the overpotential of the electrode during alkaline water electrolysis by decreasing the on-set voltage for hydrogen formation.

10. The method for producing an electrode according to claim 1, wherein the formation of electrocatalytic active nano-sites comprising Ni—S compounds capable of reducing the overpotential of the electrode during alkaline water electrolysis by decreasing the on-set voltage for oxygen formation.

11. The method for producing an electrode according to claim 1, wherein the formation of electrocatalytic active nano-sites comprising Ni—S compounds capable of reducing the overpotential of the electrode during alkaline water electrolysis by facilitating more nano-sites that can be oxidized for generating Ni-oxide-nano-sites beneficial for oxygen formation.

12. The method for producing an electrode according to claim 1, wherein the sulfiding of said Ni foam substrate is performed at a temperature interval of approximately 20-150° C., preferably at a temperature interval of approximately 50-100° C., most preferably at a temperature interval of approximately 70-80° C.

13. The method for producing an electrode according to claim 1, wherein the sulfiding of said Ni foam substrate is performed with a gas composition, preferably with minimum pressure of about 0.5 atm., 1 atm., 2 atm., 3 atm., 4 atm. or 5 atm.

14. The method for producing an electrode according to claim 1, wherein the sulfiding of said Ni foam substrate is performed with a gas composition with relative volume part of water being in the interval of approximately 0.1-20%, preferably in the interval of approximately 5-15%, more preferably around 10%.

15. The method for producing an electrode according to claim 1, wherein the electrode for alkaline electrolysis based on a Ni foam substrate is an anode part and/or the cathode part.

16. The method for producing an electrode according to claim 1, wherein the sulfiding is performed in less than 10 hours, preferably less than 5 hours, most preferably less than 2 hours.

17. The method for producing an electrode according to claim 1, wherein the electrode produced is part of an existing electrolysis system.

18. The method for producing an electrode according to claim 1, wherein a pre-treatment is performed before the sulfiding of said Ni foam, said pre-treatment comprising:
heating in a non-wetting atmosphere, or
heating in a humid atmosphere, preferably with relative humidity of 1 to 20 vol. procent, preferably 2-10 vol. procent.

19. The method for producing an electrode according to claim 1, where the step S2) of sulfiding on said Ni compound is performed with a sulfiding medium comprising hydrogen sulfide, H₂S, alternatively dimethyl sulfide (DMS), dimethyl sulfoxide (DMSO, (CH₃)₂SO), Ethyl Mercaptan (CH₃CH₂SH), Butyl Mercaptan (C₄HioS), thiourea, C₂S₂ or H₂S₂.

20. The method for producing an electrode according to claim 1, wherein the sulfiding of said Ni foam substrate is performed with a gas composition, optionally a H₂S gas, preferably with a gas composition of 1-10 vol. % H₂S, more preferably 2-4 vol. % H₂S, most preferably around 3 vol. % H₂S.

21. The method for producing an electrode according to claim 1, wherein the Ni foam is replaced by a foam from any of the metals chosen from the group consisting of Fe, Co, Cr, and/or Cu.

22. The method for producing an electrode according to claim 1, wherein the Ni foam is replaced by a Ni woven structure, a Ni plate, or a Ni mesh.

23. The method for producing an electrode according to claim 1, wherein an additional heating step is performed:
S_Pre) before optional step S1) metal deposition,
S_Inter) between optional S1) metal deposition and S2) sulfiding, and/or S_Post) after S2) sulfiding, and any combinations thereof.

24. The method for producing an electrode according to claim 1, wherein the step S2) of sulfiding of said Ni foam substrate is performed only on a surface part of the Ni foam substrate.

25. An electrode manufactured according the method of claim 1.

26. An electrolysis system comprising one or more electrodes manufactured according to claim 1.
